(19) United States
(12) Patent Application Publication
(10) Pub. No.: US 2026/0307886 A1
(43) Pub. Date: Oct. 8, 2026

(54) ACCESSORY FOR A CONTAINER

(71) Applicant: RPG Commerce Holdings Pte. Ltd., Manhattan House (SG)

(72) Inventor: Cheng Hong Soon, Kuala Lumpur (MY)

(73) Assignee: RPG Commerce Holdings Pte. Ltd., Manhattan House (SG)

(21) Appl. No.: 19/372,944

(22) Filed: Oct. 29, 2025

(30) Foreign Application Priority Data
Apr. 3, 2025 (MY) PI2025002058

(51) Int. Cl. B65D 81/38; A47G 23/02; A47J 36/34; A47J 47/16

(52) U.S. Cl. CPC B65D 81/3876; A47G 23/0216; A47G 23/0241; A47J 36/34; A47J 47/16

(57) ABSTRACT

The invention relates to an accessory for a container. Particularly, the accessory comprises a top (10, 210, 310, 410), an inner sidewall (30a, 330a, 430a, 530a), an outer sidewall (30b, 330b, 430b, 530b), and a base (20, 220, 320, 420, 520) defining a cavity which receives the container, and a plurality of apertures (15, 215) on the sidewall. The container may be a bottle, jar, vase, glass, cup, pot, can, or pan.

### CROSS-REFERENCE TO RELATED APPLICATIONS

This application claims priority pursuant to 35 U.S.C. 119(a) to Malaysia Patent Application No. PI2025002058 filed April 3, 2025, which application is incorporated herein by reference in its entirety.

### FIELD OF THE INVENTION

The invention relates to an accessory for a container, generally comprising a protective accessory for a container, such as a bottle, jar, vase, glass, cup, pot, can, or pan.

### BACKGROUND

Protective accessories serve an essential role in protecting the integrity of various types of containers. These accessories act as paddings which shield the containers by absorbing force when it is dropped, preventing breaking, deformity, and formation of punts, improving the overall shelf-life of the container.

In addition, protective accessories also reduce damage to its surroundings. For example, a hot container, when placed directly on a surface, transfers heat to the surface, causing the surface to potentially be discoloured, scored, or even breaking over time.

On the other hand, cold containers can also damage surface through condensation. Moisture seeps into the underside of the surface, which can lead to staining or even growth of mould over time.

Coasters and trivets are well known and used in the industry. However, there are several disadvantages to coasters and trivets depending on the material it is made of. For example, ceramic or metal products are often unstable, as they can slide on surfaces. Coasters or trivets made of cork absorb moisture, degrading over time and potentially grow mould if they are not dried properly, while coasters and trivets made of stone or wood coasters may have unfinished edges and scratch delicate surfaces.

Additionally, containers are often moved around during use. For example, a container may need to be passed around a large dining table. However, it could be disadvantageous or inconvenient for a user to use both hands to hold the container and the trivet to the container, making the container difficult to pass around. Worse yet, it could lead to the user scalding themselves if they are not able to securely grip the hot container. As another example, portable containers that are carried by its user in everyday settings, may also invite the same problems as earlier mentioned, and it would not be practical for the user to have to bring coasters and trivets along with them.

US 8,646,740 B1 attempts to address the limitation by providing a silicone coaster with a sleeve, into which the base of a wine glass or other stemware can be slid into, and this sleeve holds the coaster to the glass. However, the coaster only covers the base of the stemware, and does not accord protection to the body of the stemware.

Alternatively, US 8,579,133 B2 discloses a protective sleeve that encases containers to provide protection. However, the sleeves are intended solely for protecting the container, and does not offer the additional functions of being a coaster or trivet, nor do they provide protection to the surrounding of the containers.

There is therefore a need for protective accessories that allow for easy, one-handed handling, especially in dynamic situations, to ensure the safety of both the user, and the surfaces the containers interact with. Traditional options like coasters and trivets have their limitations, and more advanced alternatives are needed to address these shortcomings to ultimately extend the life of containers and avoid costly replacements.

### SUMMARY

An object of the present invention is to provide an accessory for a container which provides a protective element to the container.

A further object of the present invention is to provide an accessory for a container which provides a protective element to a surface the container is placed upon.

These and further objects, which will be apparent throughout the description, are achieved through the disclosed accessory for a container. In an embodiment of the invention, the accessory comprises a top, a base, and a sidewall, which define a cavity for receiving the container.

A plurality of apertures is present on the sidewall, where inner apertures on inner sidewall of the accessory comprises a diameter larger in size relative to outer apertures on outer sidewall of the accessory. Advantageously, the plurality of apertures aid with airflow. Even more advantageously, attachments to the accessory are possible through the presence of the plurality of apertures.

### BRIEF DESCRIPTION OF THE DRAWINGS

FIG. 1 illustrates the front view of the preferred embodiment of the accessory.

FIG. 2 illustrates the back view of the preferred embodiment of the accessory.

FIG. 3 illustrates the front view of the preferred embodiment of the accessory in transparent state.

FIG. 4 illustrates the back view of the preferred embodiment of the accessory in transparent state.

FIG. 5 illustrates the front cross-sectional view of the preferred embodiment of the accessory.

### DETAILED DESCRIPTION

The present invention will now be described in a more detailed manner in connection with the accompanying figures of the preferred embodiment. However, the present disclosure is not intended to limit the invention to the precise forms as disclosed, but rather, done so that the disclosure is thorough and complete.

The invention relates to an accessory for a container and generally comprises a protective cover or sleeve which fits snugly to the container. The protection is twofold, as it protects the container from scratching or damaging surfaces it is placed upon, or alternatively, absorbs impact if the container is dropped, preventing deformity or indents on the container.

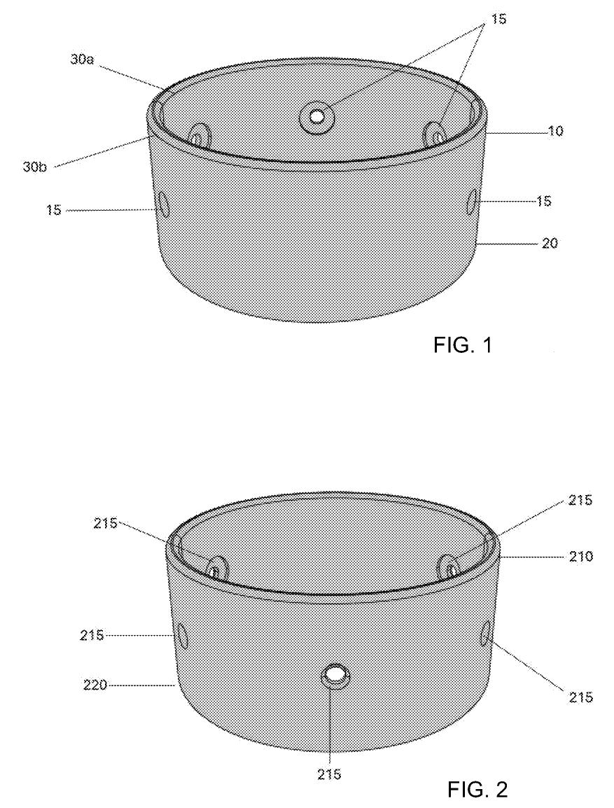

In the embodiment shown in FIGS. 1-4, the accessory is cylindrical in shape, having a top 10, 210, 310, 410, a sidewall, and a base 20, 220, 320, 420 which define a cavity. A plurality of apertures 15, 215 is present on the sidewall of the accessory to allow airflow for easy drying of liquid.

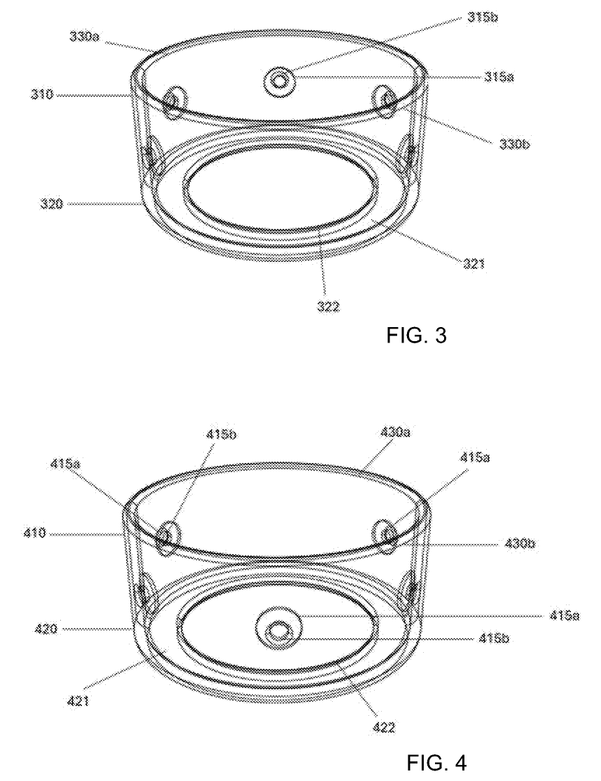

An opening at the top 10, 210, 310, 410 of the accessory receives the container within the cavity, and an annular flange 321, 421, 521 extends inwardly at the base 320, 420 (FIGS. 3-5) of the accessory to ensure the secure fit of the base of the container to the base of the accessory.

The accessory may taper slightly in size from top 10, 210, 310, 410 to the base 20, 220, 320, 420, 520 to allow easier receiving of the container to the accessory. Whilst the embodiment in FIGS. 3, 4, and 5 indicate an opening 322, 422, 522 present at the base 320, 420, 520, alternate forms may present the accessory having a flange that extends inwardly to fully enclose the base.

While the base illustrated in FIGS. 1-5 illustrates a rounded base, the base may, in alternate form, comprise a more structured, angular edge.

Apertures 15, 215 are present on the sidewall of the accessory to aid with airflow. Since spillage or condensation can be expected during usage, the apertures allow for the easier drying of liquid, reducing the growth of mould and smell. The apertures 15, 215 also allow for faster drying of the accessory when it is removed from the container and washed.

In addition, since the accessory is intended to fit snugly to the container, the plurality of apertures 15, 215 on the accessory prevents air pockets or air cushions from forming between the accessory and the container. Advantageously, any air trapped can easily escape through the plurality of apertures.

The plurality of apertures 15, 215 can be placed in a randomised order around the accessory. Alternatively, the apertures 15, 215 may be arranged in a specific pattern, such as along a straight line or diagonally.

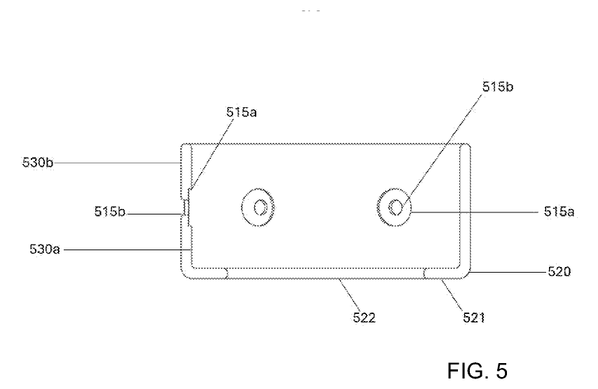

FIGS. 3 and 4 show stepped apertures, where inner aperture 315a, 415a on inner sidewall 30a, 330a, 430a is larger in diameter than a corresponding outer aperture 315b, 415b on outer sidewall 30b, 330b, 430b. The stepped apertures enable attachments to be securely attached to the accessory, if desired, without getting detached. The stepped apertures are further illustrated in a cross-sectional view of the accessory in FIG. 5.

In an embodiment, the diameter of the apertures can range from 5mm-12.4mm. Preferably, the diameters of the inner aperture range from 10-12.4mm, while the diameters of the outer apertures range from 4-6mm. Even more preferably, the diameter of the inner aperture is 12.4mm, while the inner diameter is 5mm.

In an embodiment, the attachment is securely attached to the accessory through a fastening element which may comprise a stud, pin, screw or fastener comprising a backing or stem which passes through apertures 15, 215. The backing or stem of the fastening element is flush against inner sidewall 30a, 330a, 430a, 530a enabled by the larger diameter of inner apertures 315a, 415a, 515a. The smaller outer apertures 315b, 415b, 515b ensure that the fastening element is held in place, reducing the possibility of detachment from the accessory.

In another embodiment, the backing or stem is detachable to allow easy attachment or removal of the fastening element to the accessory.

In another embodiment, the fastening element may comprise an O-ring, D-ring, square ring, carabiner clip, buckle loop, or any other appropriate fastening element not listed herein. The fastening element is secured to the accessory by passing or threading through one or more apertures 15, 215 to form a closed loop.

The fastening element allows the attachment of a handle, a strap, a keychain, a lanyard, a decorative element, a charm, a holder, or any other item not listed herein, to the accessory.

In another embodiment, the plurality of apertures on both the inner and outer wall comprises the same diameter. However, to avoid the detachment of the fastening element, the diameter is 12.4mm or less. Even more preferably, the plurality of apertures is 5mm or less.

While apertures 15, 215 illustrated in FIGS. 1-5 are circular in shape, it will be appreciated that the apertures could vary in shape and size, and in alternative form, may be in the form of a square, a diamond, or in the shape of heart, for example, for aesthetic appeal.

The thickness between the outer sidewall 30b, 330b, 430b, 530b and the inner sidewall 30a, 330a, 430a, 530a may vary based on purpose. For example, accessories intended for more delicate containers, such as glass or jars, may be thicker to provide more protection and prevent the container from breaking.

The length between the top 10 and bottom 20 of the accessory may vary based on purpose. For example, accessories intended for containers such as bottles or glasses, may be longer to act as a sleeve or cover the container in its entirety, while accessories for containers such as cups, pots, or pans, may be shorter since it primarily functions as a coaster or trivet.

In the embodiment, the accessory is of a suitable material comprising elastic material, silicone, a silicone containing material, synthetic rubber, synthetic elastomer, such a neoprene or polyurethane, or any other appropriate material not listed herein. Preferably, the accessory comprises silicone.

When fitted onto the container, the accessory acts as a physical barrier between the container and the surface it is placed upon. The soft texture prevents scratches to the surface, while the heat-resistant property of silicone prevents damage to the surface. The accessory also acts as a coaster to prevent damage to the surface from condensation.

The accessory also acts as protective layer to the container. The soft material absorbs the impact if the container is dropped, preventing deformity and the formation of punts, and further, reduces the possibility of the container breaking. Additionally, since silicone is anti-slip, unnecessary slippage or spills when placed on the surface may be prevented.

The accessory also acts as a protective layer for a user, acting as a physical barrier between the user and the bottle, allowing the user to hold the container despite the temperature of its contents.

The surface of the accessory may be smooth, or, in alternate embodiments, textured for improved grip and increased friction to enhance its non-slip properties. In yet another embodiment, the accessory may comprise finger recesses or grooves for improved grip of the container.

The container can comprise a bottle, jar, vase, glass, cup, pot, can, pan, or any other appropriate container not listed herein, and it will be known to the skilled person that minor modifications can be made to the accessory without departing from the scope of the invention.

What is claimed is:

1. An accessory for a container, comprising:
a top (10, 210, 310, 410), a sidewall, and a base (20, 220, 320, 420, 520) defining a cavity which receives the container, and
a plurality of apertures (15, 215) on the sidewall, wherein
the sidewall comprises an inner sidewall (30a, 330a, 430a, 530a) and an outer sidewall (30b, 330b, 430b, 530b), and
inner apertures (315a, 415a, 515a) on inner sidewall (30a, 330a, 430a, 530a) comprise a diameter larger in size relative to outer apertures (315b, 415b, 515b) on outer sidewall (30b, 330b, 430b, 530b).

2. The accessory of claim 1, comprising a flange (321, 421, 521) extending inwardly from the base (20, 220, 320, 420, 520).

3. The accessory of claim 2, wherein the flange (321, 421, 521) extends inwardly to fully enclose the base (20, 220, 320, 420, 520).

4. The accessory of claim 1, comprising fastening elements attachable to the accessory through the plurality of apertures (15, 215).

5. The accessory of claim 1, wherein the accessory comprises silicone.

6. The accessory of claim 1, wherein the container is a bottle, jar, vase, glass, cup, pot, can, or pan.
